(19) United States
(12) Patent Application Publication
(10) Pub. No.: US 2004/0267900 A1
(43) Pub. Date: Dec. 30, 2004

(54) Dynamic mobile device characterization

(76) Inventors: Mathew E. Hoekstra, Forest Grove, OR (US); Jose Ramirez II, Aloha, OR (US); Dhananjay Keskar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/609,112

(22) Filed: Jun. 26, 2003

(51) Int. Cl. G06F 15/177

(52) U.S. Cl. 709/217; 709/228

(57) ABSTRACT

Methods and apparatus for dynamic content customization provided to clients. When a profile repository is used to store profiles indicating typical device characteristics for various clients, the repository is configured to allow a stored profile to be flagged to indicate a client is capable of being queried for dynamically determined changes and/or additions to its stored profile. Communication between content providers, e.g., one or more servers, and the client may be configured so a minimum number of notifications need be made by the client to the servers to indicate the client can be queried for specific dynamic characteristics or deviations from a default profile (if any).

### FIELD OF THE INVENTION

The invention generally relates to dynamic content customization for devices, and more particularly to extending environments utilizing static profiles describing devices by flagging a device as being receptive to queries for dynamically determined changes and/or additions to a static profile for a device.

### BACKGROUND

Proliferation of wireless devices has led to various attempts to facilitate content delivery to various devices typically having very different characteristics, e.g., available memory, available storage, network and other communication connectivity, screen geometry, screen capabilities, processor type, processing modes, built-in services, etc. To accommodate the varying characteristics of quickly evolving and emerging devices, content providers are required to either provide their content in a in a format targeted at a least capable device that satisfies most connecting devices, which is a poor solution resulting in advanced and/or interesting features not being available to connecting devices, or the providers are required to author multiple copies of their content for display on each of the different devices desired to be supported. To provide for advanced content and/or features in the content, content providers have been forced to author different content for each of the many possible hardware and software configurations of connecting client devices, e.g., cellular telephones, personal digital assistants (PDAs), mobile computers, and the like.

In an effort to reduce multiple authoring requirements, attempts have been made to standardize on a protocol allowing a device to identify its device characteristics to a content provider, to allow the content provider to customize its output for the device. One well known attempt is the Composite Capability/Preference Profiles (CC/PP) framework promulgated by the W3C (World Wide Web Consortium). The stated goal of the CC/PP framework is to specify how “client devices” may express their capabilities and preferences (in a user agent profile) to a content provider (“origin server”). CC/PP provides a mechanism for providing device characterization data to a content provider. The CC/PP “origin server,” e.g., a content provider, uses a “user agent profile” describing a client to produce and deliver content appropriate to the client device.

CC/PP transports its data within an HyperText Transport Protocol (HTTP) header in the form of an Resource Description Framework (RDF) document, or a header is given with a link to such a document. Typically, the CC/PP protocol is used to exchange device data described as specified in the UAProf schema language defined by the Open Mobile Alliance (formerly the WAP Forum). UAProf generally specifies static properties of the device being described. It is assumed herein that the reader is familiar with the principles of CC/PP or similar protocols. For more information on CC/PP, UAProf profiles, current W3C Recommendations, and other technical documents, see Uniform Resource Locator (URL) www-w3-org/TR. (Note: to prevent inadvertent hyperlinks, periods in the preceding URL have been replaced with dashes.)

### BRIEF DESCRIPTION OF THE DRAWINGS

The features and advantages of the present invention will become apparent from the following detailed description of the present invention in which:

FIG. 1 illustrates a system including a client, content provider and central repository that may operate according to the various illustrated embodiments.

FIG. 2 illustrates an exemplary transaction flow according to one embodiment in which the server queries a client for enhanced status.

FIG. 3 illustrates a variation of the FIG. 2 embodiment.

FIG. 4 illustrates a variation of the FIG. 3 embodiment.

FIG. 5 illustrates a partial prior art UAProf Schema in the Resource Description Format (RDF) format utilized with CC/PP.

FIG. 6 illustrates use according to one embodiment of a FIG. 5 type of UAProf Schema for implementing the ProfileQuery discussed for FIGS. 2, 3 and 4.

FIG. 7 illustrates a variant of the FIG. 6 query-by-example (QBE) template.

FIG. 8 illustrates an XML XQuery embodiment of a ProfileQuery.

FIG. 9 illustrates a variation of the FIG. 1 system according to one embodiment.

FIG. 10 illustrates a suitable computing environment in which certain aspects of the invention may be implemented.

### DETAILED DESCRIPTION

The following detailed description focuses, for expository convenience, on modifying current CC/PP environment operation. Unless context requires otherwise, reference to CC/PP implies use of a UAProf type profile to share client device characteristics. It will be appreciated by one skilled in the art that CC/PP and UAProf is discussed below due to their current common usage, and the principles disclosed herein are applicable to other environments analogous to CC/PP.

In a conventional CC/PP environment, one cannot easily accommodate dynamic changes in the capabilities provided by current, improved or emerging clients. That is, one cannot store in client's “characteristic profile,” e.g., a UAProf type of profile, dynamic client characteristics such as the client's current network speed, remaining battery charge remaining, network QoS, processing load, etc. These characteristics are not discoverable by CC/PP. Instead, under CC/PP, since different servers may respond to HTTP requests, content providers are required to receive all static characteristics (or link thereto) exposed by the client with every HTTP transaction between the client and the content provider. As used herein and the claims that follow, “content provider” or “provider” will be used to generally reference a content provider and any servers, web servers, services, hardware, etc. required to receive and act on client communications. Since a client may have many characteristics, and its communication link may be slow, it may take significant time to repeatedly transfer the client's characteristics.

To partially resolve this issue, CC/PP does allow a client to identify, e.g., by way of a URL, a location of a central repository storing a default profile of characteristics for the client, where the client is allowed to send the server the differences over the default profile. But, as noted above, since different servers may respond to HTTP requests, CC/PP requires the client to provide the entire set of difference characteristics with each HTTP request. This is inefficient. Another drawback to many CC/PP implementations is that content providers may be only interested in one or two specific properties of the client, but the client is required to send out all characteristics.

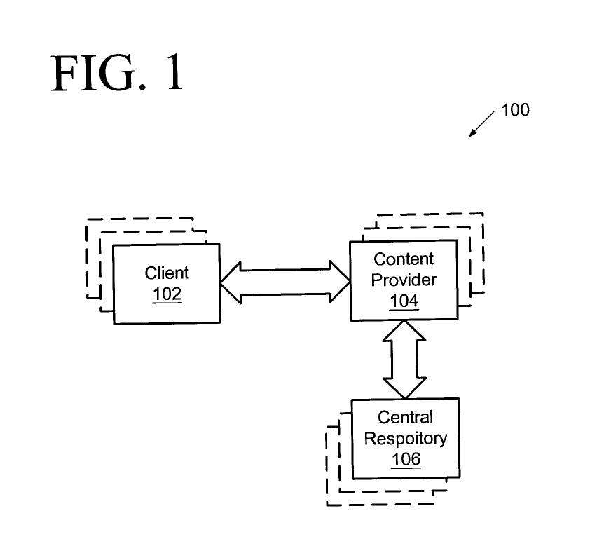

FIG. 1 illustrates a system 100 illustrating a client 102, content provider (e.g., a server or other machine providing content) and central (profile) repository 106 that may operate according to the various illustrated embodiments. Illustrated are at least one client 102, at least one content provider 104, and a central repository 106. There may be multiple clients, providers, and repositories (represented by dashed lines), however for convenience in presentation, only one of each are illustrated and discussed herein. The client 102 is a device having various characteristics, static and/or dynamic. The content provider is able to query the client, as will be discussed further below, for particular client characteristics without running into the inefficiencies discussed above with respect to CC/PP and related environments.

As with a conventional CC/PP environment, the central repository 106 may store default profiles for clients 102 in an associated database 108 or other data storage construct. However, it is contemplated that unlike a conventional UAProf or similar environment used to track client characteristics, in the illustrated embodiment, the central repository may flag a particular client as being “enhanced” and therefore supporting a content provider 104 obtaining specific characteristics of a client and/or dynamic information about the client. It will be appreciated that the central repository is optional. The client may directly contact a content provider and indicate it is enhanced, or the content provider on receiving contact may query the client for enhanced status.

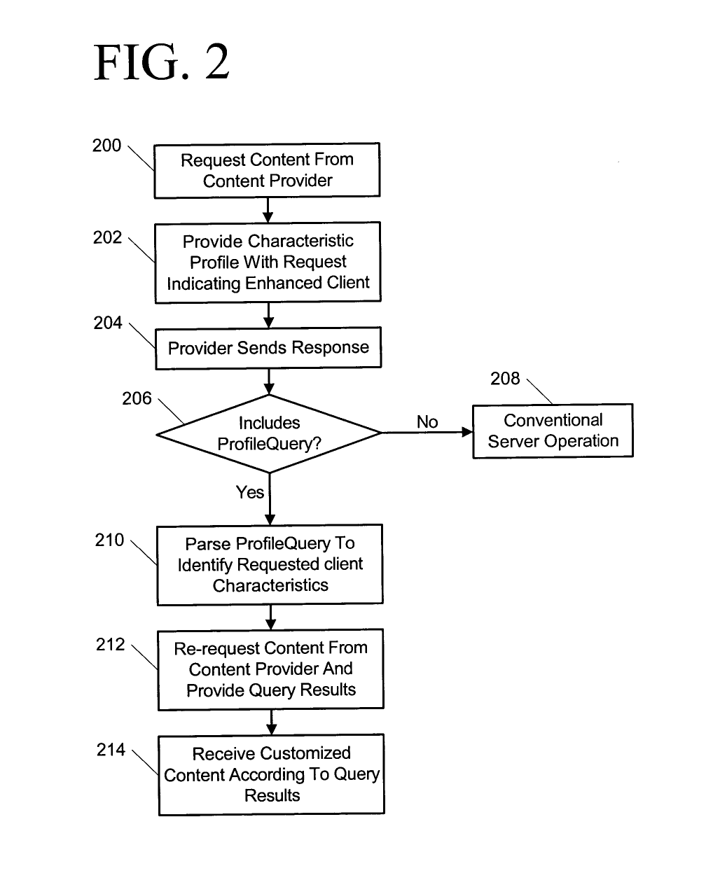

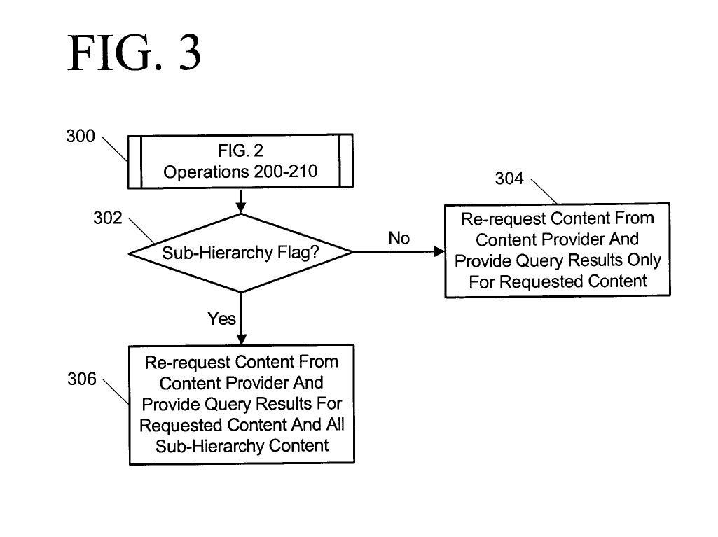

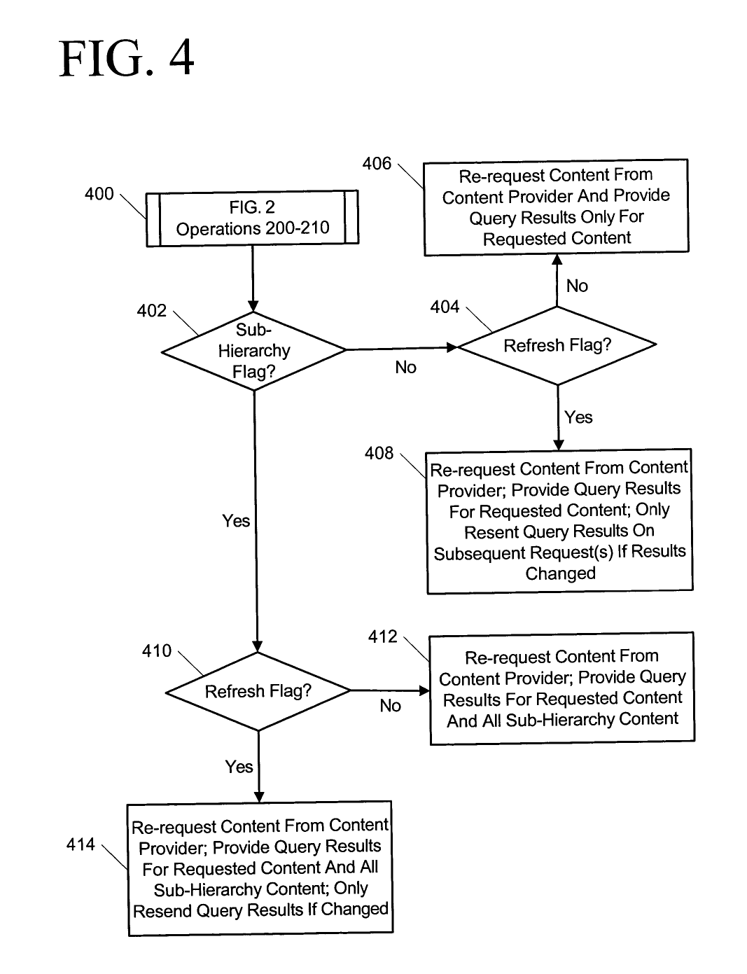

FIG. 2 illustrates an exemplary transaction flow according to one embodiment in which the server queries a client for enhanced status. In this embodiment, a client 102 and a content provider 104 may utilize conventional CC/PP messaging to exchange device capabilities. In the illustrated embodiment, the client is responsive to queries, such as ones embedded in HTTP response headers that may be added by the content provider responsive to client contact to signal the content provider wants additional and/or dynamic information about the client.

In the illustrated embodiment, a client 102 requests 200 some content from the content provider 104. The requesting may be by way of a browser of the client issuing an HTTP request requesting data, such as a web page, from an HTTP server for the content provider. Assuming a CC/PP type of environment is utilized, along with the HTTP request, the client also sends 202 its characteristic profile, e.g., a UAProf type profile, to the HTTP server, where the characteristic profile indicates the client is “enhanced,” e.g., it may be queried for non-static information.

In one embodiment, indicating the client is enhanced is accomplished by modifying a conventional UAProf description profile to include in the SoftwarePlatform CC/PP section (for identifying software platform characteristics of the client) an additional property named ProfileQuerySupported with a value of “Yes”. When the content provider 104 receives the characteristic profile, it parses the request 200 for content, parses the sent 202 characteristic profile, and sends 204 a response.

However, rather than immediately providing the requested resource, instead the provider simply returns an HTTP 200 (“OK”) response with default data, such as an empty page, a placeholder page which may indicate the provider needs additional information, the requested content not customized for the client device, or other response. There are circumstances where sending the not-customized data is beneficial, such as when the client might be unable to support a query, such as due to the query functionality being disabled, the client running low on resources, etc. In such cases, the client could just show the non-customized content rather than make a subsequent request for customized content. Note that in a significant number of cases, the initial “page” from the site may in fact be a frame-set with several links to embedded pages within frames. Even for non-frame-set content, there are a large amount of embedded links to images, table data, etc. A browser therefore does a number of subsequent GET requests to completely render the initial page.

Along with the HTTP 200 response204, assuming the content provider 104 needs additional information about the client 102 before providing the originally requested 200 content, the server also embeds an additional HTTP header named ProfileQuery, e.g., an HTTP extension header or equivalent. Within the ProfileQuery is a query for additional information, e.g., particular device characteristics that the provider desires to know. For example, the provider may wish to know a client's current processor speed and available memory.

Note that if a provider has inadvertently sent a ProfileQuery header to a client that cannot understand the HTTP extension header, the client is presumed to operate according to conventional web processing guidelines and ignore unknown headers. In the illustrated embodiment, the client 102 understands the extension, and therefore after the provider 104 sends 204 its response, the client tests if 206 the provider has embedded a ProfileQuery. If not, then the client deals 208 with the provider conventionally. For example, the provider may have in fact sent 204 the client a valid response, e.g., the provider did not need further information from the client to provide the requested 200 content, and therefore there is no need to embed an extension header.

If 206 the ProfileQuery was present, the client 102 parses 210 the ProfileQuery to identify what characteristic or characteristics are desired by the content provider 104. After determining the requested characteristics, hereafter “query results,” in the illustrated embodiment, the client re-requests 212 the content from the content provider, but this time the request incorporates the characteristics desired by the provider. Alternatively, in cases where the initial page was a frame-set, or where sub-requests are made to finish rendering the page, the query results are incorporated into the characteristics accompanying the sub-requests. In one embodiment, the client uses the CC/PP protocol to identify and provide the query results within return HTTP headers.

After the content provider 104 receives and processes the supplied query results, the client 102 receives 214 the requested content formatted according to the supplied client characteristics. In such fashion, provided content may be dynamically optimized to the current operating condition of a requesting client 102, instead of requiring the provider to assume a least-capable environment, tailor results to a generic profile of the client, or require the client to continually identify values that differ over a standard profile.

In the illustrated embodiment, it is assumed the client 102 receives and responds to a ProfileQuery received from the content provider 104. It should be appreciated by one skilled in the art, however, that in another embodiment some or all responses may instead be determined by a third party (not illustrated), e.g., proxy, external monitoring service, virtual machine monitor (VMM) if the client is a virtual machine (VM), etc., that is in a position to know the information desired by the provider. The third party may then provide the results to the client for incorporation by the client into responses given to the provider, or, the third party, if acting as a middle-man, may dynamically alter responses from the client to include the query results.

FIG. 3 illustrates a variation of the FIG. 2 embodiment. In the illustrated embodiment, initial operation 300 is roughly (e.g., not necessarily identical) equivalent to the preceding discussion of FIG. 2 operations 200-210. However, unlike FIG. 2, after parsing 210 the ProfileQuery, the client 102 tests if 302 the content provider 104 has embedded a sub-hierarchy flag.

In the illustrated embodiment, if the sub-hierarchy flag is present, the content provider 104 is indicating that the determined 210 query results are to be provided along with all HTTP request for the requested 200 content, as well as any content located lower down in the document hierarchy, e.g., sub-pages of the web page of the requested content. In one embodiment, the content provider embeds an HTTP Set-ProfileCookie extension header to indicate the application of query results to a sub-hierarchy. Client responsive behavior is similar to that of responding to a Set-Cookie header as defined in the HTTP 1.1 protocol specification, e.g., for appropriate pages the client returns the cookie value to the content provider. In one embodiment, the sub-hierarchy is implemented as a cookie sent to the client. Cookies may be set through use of a response header, JavaScript, or DHTML (Dynamic HyperText Markup Language, and used to identify the hierarchy of content for which query results should be returned.

If 302 a sub-hierarchy flag was not present, in one embodiment the client operates as in FIG. 2 operation 212, e.g., it re-requests content from the provider, and passes the provider the determined characteristics in accord with the ProfileQuery. If 302 the sub-hierarchy flag was present, in one embodiment, for each HTTP request where the client would send the cookie specified in the Set-ProfileCookie header back to the content provider, the client also sends 306 the query results determined for the ProfileQuery. It will be appreciated that the client may send the determined characteristics to the provider in various ways, including in accord with the CC/PP protocol or by embedding the results in the cookie returned to the content provider.

FIG. 4 illustrates a variation of the FIG. 3 embodiment. In this embodiment, initial operation 400 is assumed roughly (e.g., not necessarily identical) equivalent to the preceding FIG. 3 discussion of operations 300-302.

However, unlike FIG. 3, if 402 a Sub-Hierarchy flag was not received from a content provider 104, the client 102 may test if 404 the content provider has embedded a refresh flag. In one embodiment, after initially providing the content provider with the query results, the refresh flag tells the client it need only re-send the query results to the content provider if the query results have changed, e.g., the refresh flag tells the client it may assume the content provider will cache previously submitted query results. In one embodiment, as with the ProfileQuery, the refresh flag may be implemented with an HTTP extension header named ProfileRefreshFrequency having a value of “send-updates” or some other value indicative of how and/or when the client should send query updates.

If 402, 404 the provider has not set a sub-hierarchy flag and has not set a refresh flag, then client re-requests 406 its desired content from content provider 104 and provides query results to the content provider only for the requested content. If the client subsequently requests content from a sub-page of the requested content, or the query results change, the content provider is not re-provided the results or notified of their change. Instead, it is assumed the content provider is responsible for sending another ProfileQuery to the client if it desires dynamic information about the client.

If 402 the content provider 104 has not set a sub-hierarchy flag, but did set (404) the refresh flag, then the client re-requests 408 its desired content from content provider 104, and provides query results for the requested content as discussed above. But, in the illustrated embodiment, if the then client subsequently re-requests the same content from the content provider, the client does not resend the query results to the provider unless the results have changed. Unlike a conventional CC/PP type of environment which allows a client to alter its profile by submitting profile changes along with every HTTP transaction, as illustrated the client may assume that the content provider has cached the results initially sent to the provider and the client will not send the query results in subsequent requests to the same content unless the query results have changed.

If 402 the provider has set the sub-hierarchy flag, but has not set a refresh flag, then as discussed above for FIG. 3 operation 306, the client re-requests 412 the desired content from the content provider, provides the query results for the ProfileQuery, and the client automatically provides the query results for all requested sub-pages of the requested content.

If 402, 404 the content provider set the sub-hierarchy flag and the refresh flag, then the client re-requests 414 the content from content provider, sends the content provider the query results for requested characteristics of the client when accessing the current requested content and for all sub-hierarchy content, e.g., sub-pages. However, in this embodiment, query results are only sent once or when changed; previous unchanged results are presumed cached by the provider.

To implement the refresh flag, in one embodiment, as discussed above for FIG. 2, the content provider may embed an HTTP Set-ProfileCookie extension header. The client responsive behavior may be made similar to that of responding to a Set-Cookie header as defined in the HTTP 1.1 protocol specification, e.g., for appropriate pages the client returns the cookie value to the content provider. However, in the illustrated embodiment, an unlike FIG. 3, rather than sending in the query results each time the client would return the cookie value, instead the client tests for query result changes and determines whether updated results need to be sent. In one embodiment, when sending updates, the client only sends updates along with the cookie. A provider, when receiving a cookie along with query results, can presume that the results are an update to previously received updates, if any.

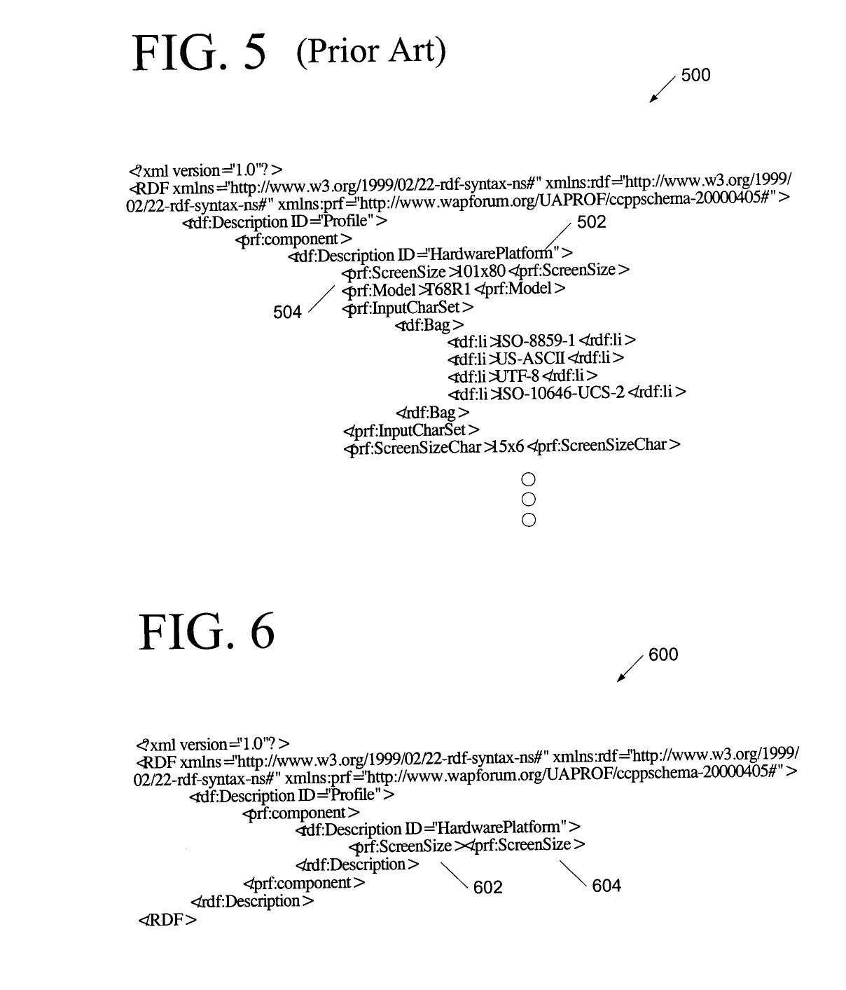

While the foregoing embodiments have referenced UAProf profiles, FIG. 5 illustrates a partial prior art UAProf Schema 500 in the Resource Description Format (RDF) format utilized with CC/PP. FIG. 5 exemplifies the limitations inherent to CC/PP, namely that the information intended to be presented in the profile about a client is static listing of the client's characteristics. For example, while the profile may include a Hardware Platform 502 section defining a Screen Size 504, etc., one cannot determine a currently available screen size, which may be a dynamic value dependent on whether other applications, processes or output is utilizing screen resources. For example, a stock ticker program may be consuming a bottom portion of a display.

FIG. 6 illustrates use according to one embodiment of a FIG. 5 type of UAProf Schema for implementing the ProfileQuery discussed for FIGS. 2, 3 and 4.

In the illustrated embodiment, a query-by-example (QBE) template 600 is defined as a UAProf type RDF document in which certain entries are defined but not given values. When a client 102 requests content from a content provider 104, if a responsive ProfileQuery is received from the provider, the client parses the QBE template to identify defined entries lacking values, and those missing entries are filled in, if possible, and the completed QBE template becomes the “query results” discussed above that are sent back to content providers responsive to their ProfileQuery.

In the illustrated embodiment, for example, the ProfileQuery QBE template 600 indicates the provider desires to know the client's current screen size since the received UAProf profile defines an empty Screen Size 602 entry is empty, e.g., there is no value indicated between the open 602 and close 604 tags for the Screen Size. It will be appreciated that a QBE template may be defined that defines but does not give a value to any other dynamic client characteristics or its environment, such as available memory, available storage, processor speed, number of processors, operating system, specialized hardware available to the client (e.g., encryption processors, graphics processors, etc.), wireless resources, available power, available peer devices, screen colors, availability of a camera, microphone, availability of text to speech and speech to text capabilities, soft radio algorithms, other audiovisual features, etc.

The queried values may be dynamic, and as discussed above, through use of embodiments utilizing the refresh flag, the client may be instructed to notify a content provider when queried values have changed. In one embodiment, tolerances may be associated with queried values, such as by way of defining a tolerance variable within the open tag for a queried value. The client, if able to process the tolerance setting, would only update dynamic variables if the previously sent value has changed in excess of the tolerated value. This would allow a rapid series of HTTP communications between a client and content provider without the overhead of reporting every dynamic value change.

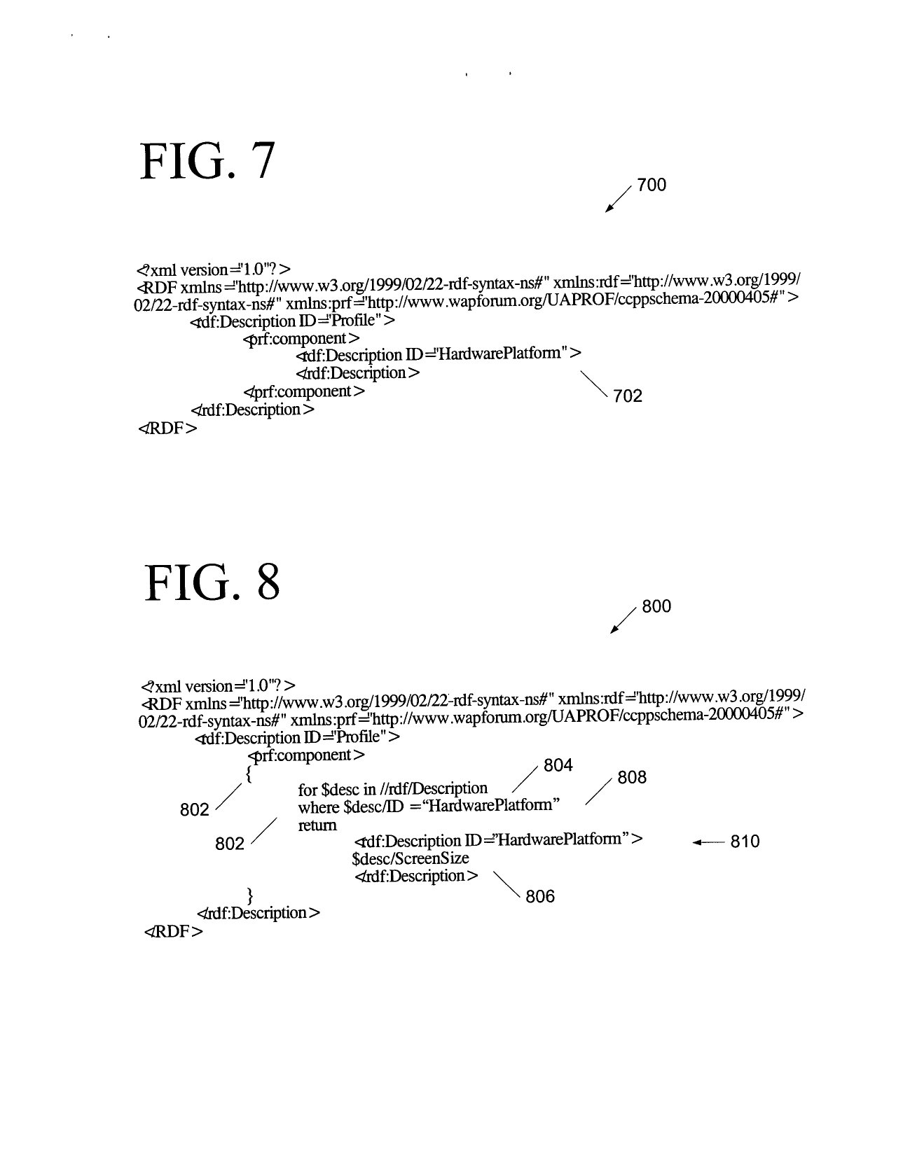

FIG. 7 illustrates a variant of the FIG. 6 query-by-example (QBE) template. In the illustrated embodiment of the QBE template 700, the Hardware Platform entry 702 of the RDF definition is completely empty. When a client 102 receives this profile query, the client responds by identifying every characteristic of the client that is known to the client. One possible purpose to such a query is to allow a content provider 104 to see how the client's view of itself differs from a standard definition, e.g., one that might be maintained by a central (profile) repository 106. It will be appreciated that other purposes may be met by getting a complete characteristic profile from a client. For example, when if a new device comes to market, complete profiles may be collected and stored for later use or analysis.

FIG. 8 illustrates an XML XQuery embodiment of a ProfileQuery. In this embodiment, instead of using a UAProf document, instead the ProfileQuery is implemented as an XML XQuery 800. For more information on the structure of an XQuery, see the W3C XQuery working draft located at Uniform Resource Locator (URL). http://www-w3-org/TR/xquery (Please note, to prevent inadvertent hyperlinks, the periods in the preceding URL were replaced with dashes.)

In the illustrated embodiment, XQuery code 802 may be constructed that results in a search being performed through a particular RDF description 804 (an XML based data source storing the set of client characteristics known to a client), for a particular definition, such as the ScreenSize 806 value in the HardwarePlafform 808. One skilled in the art will appreciate that the XQuery differs from the QBE templates discussed above in that the XQuery may explicitly include the XML code necessary for the client to search through its XML data source of known client characteristics to locate the characteristic of interest to the content provider, e.g., the ScreenSize 806. This would allow, for example, establishing a query that first identifies certain characteristics of a client, and then uses that characteristic to determine what other characteristics may be of interest. For example, a provider might not care about graphics hardware if the client is known to have limited processor power. It will be appreciated that a QBE template, XQuery, or some combination of the two may be used to identify client characteristics of interest to a content provider.

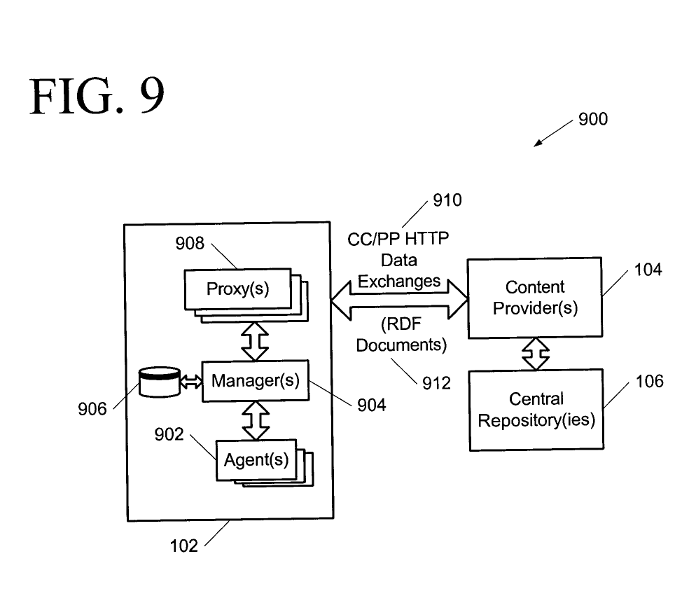

FIG. 9 illustrates a variation of the FIG. 1 system according to one embodiment. Shown is a system 900 of devices including client software and/or hardware, e.g., client items 902-908, engaging in data exchanges, such as CC/PP HTTP data exchanges 910 of RDF documents 912, for responding to a ProfileQuery.

In the illustrated embodiment, the client 102 includes at least one Agent 902 that queries the client platform for one or more dynamic client characteristics, e.g., Agents may be specialized. The client also includes at least one Manager 904 for managing Agents. It is assumed that Agents may be dynamically added and removed, as necessary, through an Application Programming Interface (API) or equivalent programmatic interface to the Manager. In one embodiment, Insert or removal of client hardware and/or software may result in a corresponding event notification resulting in triggering an API to add or remove an appropriate Agent. Thus, changes in a client's configuration may result in the dynamic addition/deletion of Agents without requiring the client to be restarted or otherwise reset.

In one embodiment, on initialization of the client 102, e.g., power-up, power-on, restart, etc., the Manager 904 loads a profile for the client and stores it. It is assumed the static profile is located in a storage 906 in or other wise accessible to the client. In one embodiment, the profile may identify static entries such as entries that would be in a conventional CC/PP UAProf profile, as well as dynamic entries for characterizing dynamic client characteristics indicating the current state of the client. In an alternate embodiment, the Manager initially loads the profile from a central repository 106 if one can not be obtained from the client.

When a content provider 104 sends a profile query, e.g., a ProfileQuery HTTP header as discussed above, a Proxy 908 receives the query and forwards it to the Manager 904. In the illustrated embodiment, the Proxy operates essentially like a conventional web server proxy, e.g., it operates as the conduit through which the client communicates with the outside world, and it may listen on a particular communication channel, such TCP/IP (Transmission Control Protocol/Internet Protocol) port 80, for incoming data. It will be appreciated that there may be multiple proxies utilizing one or more protocols to attend to different communication needs.

In one embodiment, the Proxy 908 maps profile queries to API calls to the Manager 904 to obtain characterization data of the client 102. For example, a content provider may send a ProfileQuery for the screen size of the client. This request passes through the Proxy which parses (see, e.g., FIG. 6) the ProfileQuery, identifies the requested information, and issues an API call requesting the Manager to determine the client's screen size. In one embodiment, the Manager 904 answers queries by sending its stored profile to the Agent 902 so that the Agent may update the profile with current, e.g., up to date, values. If an appropriate Agent is not currently loaded that can respond to the query, the Manager may load that Agent dynamically. In one embodiment, the Agent 902 tracks necessary objects, libraries, data sources, etc. (not illustrated) that may be called upon by the Agent for determining the characteristic or characteristics of the client for which the Agent is responsible. In one embodiment, on initialization of the client 102, after copying the client's profile, the Manager 904 asks appropriate Agents 902 to update all dynamic entries in the Manager's stored profile.

Updated profile data is received by the Manager 904 from the Agent 902 and is in turn provided to the Proxy 908 for delivery as query results to the requesting content provider 104. In one embodiment, to increase communication efficiency and reduce network requirements, only differences over a standard, e.g., static profile for the client are returned to the content provider.

It will be appreciated by one skilled in the art that some implementation details have been left out to ensure presentation clarity. For example, it will be appreciated that the Manager may send its entire profile to each Agent 902, and the Agent then self-selects data for which it is responsible for updating, or the Manager may send sub-profiles to Agents pre-determining the information the Agent is being requested to determine. For example, a single Agent may be responsible for determining both screen size, as well as color depth and RAMDAC (Random Access Memory Digital-to-Analog Converter) used by the client. The Manager may present the Agent with a sub-profile only identifying the screen size, thus resulting in only that value being determined by the Agent.

It will be further appreciated by one skilled in the art that even though the detailed description has focused on CC/PP data transfers, different data schemas may be utilized using the provided Manager 904 and its related API. Thus, the illustrated embodiments of the invention may be implemented without requiring change to the CC/PP and/or UAProf standards, but may instead work alongside these standards to allow exposure of all properties of a client, whether static or dynamic

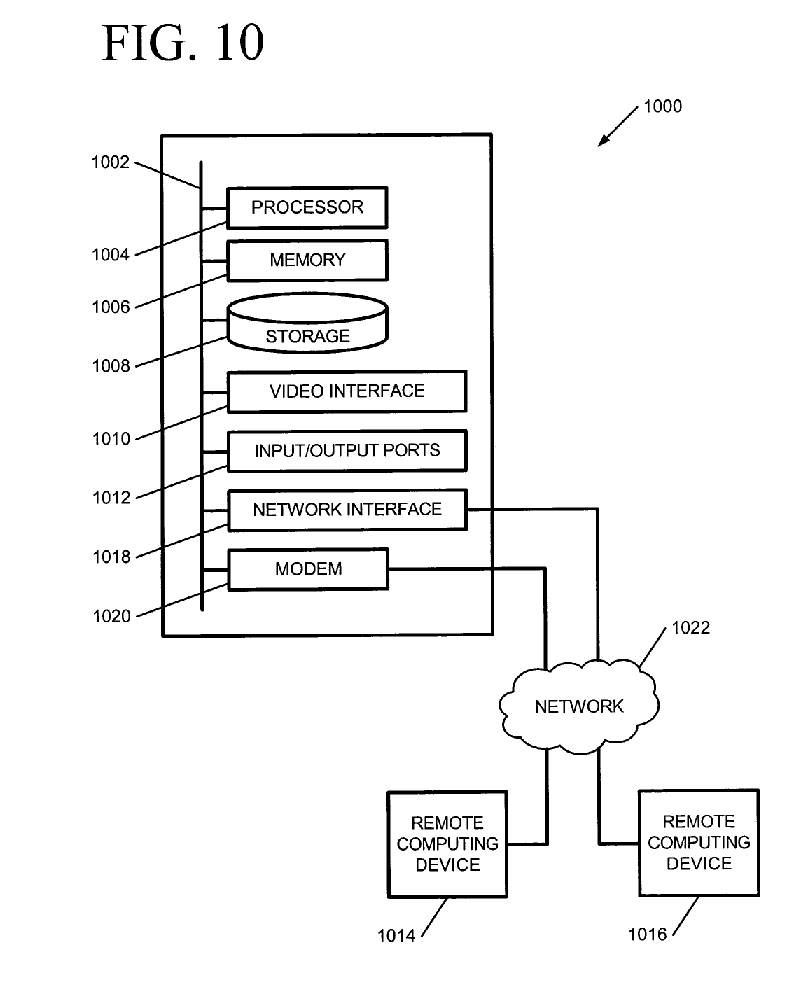

FIG. 10 and the following discussion are intended to provide a brief, general description of a suitable environment in which certain aspects of the illustrated invention may be implemented.

As used herein below, the term “machine” is intended to broadly encompass a single machine, or a system of communicatively coupled machines or devices operating together. While the preceding description has focused on particular machines, e.g., client 102, content provider 104, central repository 106, the term “machine” is intended to include all manner of computing devices, such as personal computers, workstations, servers, portable computers, handheld devices, e.g., Personal Digital Assistant (PDA), telephone, tablets, etc., as well as transportation devices, e.g., automobiles, trains, cabs, etc. For example, the client 102 may be disposed in any of these possible machine embodiments, e.g., the client may be a cellular phone or PDA.

Typically, the environment includes a machine 1000 that includes a system bus 1002 to which is attached processors 1004, a memory 1006, e.g., random access memory (RAM), read-only memory (ROM), or other state preserving medium, storage devices 1008, a video interface 1010, and input/output interface ports 1012. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 1014, 1016, such as through a network interface 1018, modem 1020, or other communicative coupling. Machines may be interconnected by way of a physical and/or logical network 1022, such as an intranet, the Internet, local area networks, and wide area networks. One skilled in the art will appreciated that communication with network 1022 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine, e.g., executed by a processor, results in the machine performing tasks or defining abstract data types or low-level hardware contexts. Associated data may be stored in, for example, volatile and/or non-volatile memory 1006, or in storage devices 1008 and their associated storage media, including hard-drives, floppy-disks, optical storage, tapes, flash memory, memory sticks, digital video disks, biological storage, etc. Associated data may be delivered over transmission environments, including network 1022, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 1000 embodies client 102, then remote machines 1014, 1016 may respectively be a content provider 104 and a central repository 106 storing a default profile for the client. It will be appreciated that remote machines 1014, 1016 may be configured like machine 1000, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for a client, comprising:
first requesting a first content from a content provider;
providing a characteristic profile to the content provider indicating characteristics of the client;
receiving a first reply from the content provider responsive to the first requesting, the first reply including a query for a characteristic of the client;
second requesting the first content from the content provider, the second requesting incorporating a query result for the query; and
receiving a second reply from the content provider responsive to the second requesting, the second reply including the first content or portion thereof, wherein the first content or portion thereof is determined based at least in part on the characteristic.

2. The method of claim 1, further comprising:
third requesting a second content from the content provider, wherein the third requesting automatically incorporates the query result for the query.

3. The method of claim 1, wherein for content that is arranged in a hierarchical structure, the method further comprising:
determining if the content provider wants the query result to be automatically incorporated into a third requesting of second content from the content provider that is lower in the hierarchical structure than the first content.

4. The method of claim 3, further comprising:
determining if the content provider is caching the query result, and if so, determining if the query result has changed since the first requesting; and
wherein if the query result has not changed, said third request does not incorporate the query result for the query.

5. The method of claim 4, wherein if the query result has changed, said third request automatically incorporates the query result for the query.

6. The method of claim 2, further comprising:
determining if the content provider is caching the query result, and if so, determining if the query result has changed since the first requesting; and
wherein if the query result has not changed, said third request does not incorporate the query result for the query, and wherein if the query result has changed, said third request automatically incorporates the query result for the query.

7. The method of claim 1, further comprising:
storing the query result in a HyperText Transport Protocol (HTTP) request header provided to the content provider.

8. The method of claim 1, wherein the query is received in a HyperText Transport Protocol (HTTP) response header provided by the content provider.

9. The method of claim 1, wherein requesting the content and receiving the first reply is performed according to the Composite Capability/Preference Profiles (CC/PP) protocol.

10. The method of claim 1, wherein the characteristic profile includes an entry indicating whether the client can be queried for an operational characteristic.

11. The method of claim 10, wherein the characteristic profile is formatted as a UAProf profile.

12. The method of claim 1, wherein the first reply comprises a selected one of the content or a frame-set for the content.

13. The method of claim 1, wherein the characteristic is a selected one of processor type, processor speed, processor mode, available memory, available storage, or available network connectivity.

14. The method of claim 1, wherein the characteristic is a selected one of availability of: peer clients, a camera, a microphone, a text to speech converter, a speech to text converter, a soft radio, a graphics processor.

15. The method of claim 1, wherein the characteristic is availability of an encryption processor.

16. A method, comprising:
receiving from a client a first request for first content and a characteristic profile indicating characteristics of the client;
providing a first response to the client lacking all of the requested first content, but wherein the first response incorporates a query for a characteristic of the client;
receiving a second request for the first content, wherein the second request incorporates a query result for the query; and
providing the first content to the client in accord with the query result.

17. The method of claim 16, further comprising:
wherein the characteristic profile indicates the client may be queried for characteristics not identified in the characteristic profile;

18. The method of claim 16, wherein the characteristic reflects an operational characteristic of the client.

19. The method of claim 18, wherein the operational characteristic is a real-time attribute which changes while the client is operating.

20. The method of claim 18, wherein the operational characteristic is a selected one of available power, available memory, processor type or processor speed.

21. The method of claim 16, further comprising:
issuing a set-cookie command to the client to associate at least the first content with a cookie, wherein the cookie indicates the query result will be cached for all content associated with the cookie.

22. A system comprising:
a content provider communicatively coupled with a client;
wherein the content provider is operative to perform receiving from the client a first request for content, determining the client may be queried for characteristics, providing a response to the client incorporating a query for a characteristic of the client, receiving a second request for the first content incorporating a query result for the query, and providing the first content to the client in accord with the query result; and
wherein the client is operative to perform parsing the response to determine the query, determining the query result, and providing the query result to the content provider in at least a second request for content.

23. The system of claim 22, wherein the client and content provider utilize HTTP to exchange data in accord with the CC/PP protocol.

24. A system comprising:
a proxy for managing communication with a content provider, the proxy operable to parse data received from a content provider to determine a query for a characteristic of the system, and to provide a query result to the content provider incorporating the characteristic of the system;
at least one agent for inspecting the system for various characteristics of the system; and
a manager having an interface communicatively coupled with the proxy to allow the proxy to direct the manger to dynamically instantiate an agent to determine the query result responsive to the query.

25. The system of claim 24, the system further comprising a memory for storing directives for at least the manager, the directives including:
a first directive to store a copy of a default characteristic profile for the system into the memory;
a second directive to identify an entry in the copy for which the agent is required to determine a value;
a third directive to dynamically load the agent to determine the value;
a fourth directive to store the value in the copy of the default characteristics profile.

26. An article comprising a machine-accessible media having associated data, wherein the data, when accessed, results in a machine performing:
first requesting a first content from a content provider;
providing a characteristic profile to the content provider indicating characteristics of the client;
receiving a first reply from the content provider responsive to the first requesting, the first reply including a query for a characteristic of the client;
second requesting the first content from the content provider, the second requesting incorporating a query result for the query; and
receiving a second reply from the content provider responsive to the second requesting, the second reply including the first content, wherein the first content is determined based at least in part on the characteristic.

27. The article of claim 26 wherein the machine-accessible media further includes data, when accessed, results in the machine performing:
determining the content is arranged in a hierarchical structure; and
determining if the content provider wants the query result to be automatically incorporated into a third requesting of second content from the content provider that is lower in the hierarchical structure than the first content.

28. An article comprising a machine-accessible media having associated data, wherein the data, when accessed, results in a machine performing:
receiving from a client a first request for first content and a characteristic profile indicating characteristics of the client;
determining the client may be queried for characteristics not identified in the characteristic profile;
providing a first response to the client lacking all of the requested first content, but wherein the first response incorporates a query for a characteristic of the client;
receiving a second request for the first content, wherein the second request incorporates a query result for the query; and
providing the first content to the client in accord with the query result.

29. The article of claim 28 wherein the machine-accessible media further includes data, when accessed, results in the machine performing:
issuing a set-cookie command to the client to associate at least the first content with a cookie, wherein the cookie indicates the query result will be cached for all content associated with the cookie.
